(19) United States
(12) Patent Application Publication
(10) Pub. No.: US 2024/0389552 A1
(43) Pub. Date: Nov. 28, 2024

(54) METHOD FOR AUTOMATED ANIMAL MANAGEMENT, PARAMETER DETERMINATION SYSTEM, ANIMAL MANAGEMENT SYSTEM, AND USE

(71) Applicant: Nedap N.V., Groenlo (NL)

(72) Inventors: Jeroen Martin VAN DIJK, Enschede (NL); Derk Jan ROOSENBOOM, Haaksbergen (NL)

(21) Appl. No.: 18/693,576

(22) PCT Filed: Sep. 21, 2022
(86) PCT No.: PCT/NL2022/050529

§ 371 Date: Mar. 20, 2024

(30) Foreign Application Priority Data
Sep. 21, 2021 (NL) 2029217

(51) Int. Cl. A01K 11/00; A01K 29/00

(52) U.S. Cl. CPC A01K 11/006; A01K 29/005

(57) ABSTRACT

Method for automated animal management, comprising: using an animal management system including a plurality of wireless communication devices, each of the wireless communication devices having a respective identifier associated therewith in the system; assigning a first one of the wireless communication devices to an animal management effector and registering, in the animal management system, an indication of the assigning; causing a second one of the wireless communication devices to be carried by an individual animal; using the respective identifier of at least one of the first and second wireless communication devices, causing a wireless communication between at least said first and second wireless communication devices; and automatically determining, by the animal management system, using the registered indication of the assigning, at least one parameter of an animal management relationship between the animal and the animal management effector in dependence of the wireless communication.

### FIELD

The invention relates to a method for automated animal management of at least one animal, as well as to a parameter determination system for use in such a method, to an animal management system, and to use of such systems in such a method.

### BACKGROUND

Automated animal management, for example in the livestock industry, is known to provide advantages over more traditional methods of animal management. For example, keeping track of an animal's whereabouts, performance and needs can be made easier and more accurate by known forms of automated animal management. In some cases, such automated tracking or other sensing can even trigger an automated animal management action. For example, a gate may open or close automatically depending on an automated determination that a particular animal is or is not present at the gate.

In view of ongoing economic, environmental and animal welfare considerations, there remains a desire for further improvements in the area of automated animal management.

### SUMMARY

An object of the present invention is to provide an improved method for automated animal management of at least one animal, wherein in particular an ease of use, versatility, accuracy, reliability and/or cost saving of the method is improved and/or maintained. An object is to at least provide an alternative.

An aspect of the invention provides a method for automated animal management of at least one animal. The method comprises using an animal management system including a plurality of wireless communication devices, each of the wireless communication devices having a respective identifier associated therewith in the system. A first one of the wireless communication devices is assigned to the animal management effector, and an indication of the assigning is registered in the animal management system.

The method further comprises causing a second one of the wireless communication devices to be carried by an individual animal of the at least one animal, and causing a wireless communication between at least said first and second wireless communication devices using the respective identifier. In dependence of the wireless communication, and using the registered indication of the assigning, the animal management system automatically determines at least one parameter of an animal management relationship between the animal and the animal management effector.

The method advantageously provides improved versatility and ease of use, in particular with respect to known methods in which no such wireless communication device is assigned to the animal management effector and/or in which an indication of such assigning is not registered. For example, since the wireless communication devices can thus each be of a same type and/or mutually interchangeable, a user can substantially randomly select a wireless communication device from a set of such devices, and assign the selected device to the animal management effector as desired in view of one or more animal management goals. This prevents any need for dedicated and/or custom communication means for such an animal management effector, for example communication means which have been integrated with the animal management effector during production thereof.

Moreover, an animal management effector which was originally not provided with any such communication means may thus be provided with one or more respective wireless communication devices to thereby enhance the effector's usability, observability and/or controllability in terms of its function and/or role within animal management. Thus, it allows the assignment of wireless communication devices to any arbitrary animal management effector, regardless of its nature or function; e.g. even ordinary fences or gates may be assigned a wireless communication device.

As a further possibility, an animal management effector such as a boundary between areas may essentially be defined by its respective one or more wireless communication devices. In other words, an animal management effector may thus be created which is otherwise substantially virtual, i.e. as opposed to a possible physical effector such as a physical object, structure, machine, building, or the like. In this manner, a farmer may for example define a virtual area between three or more wireless communication devices, and count or register any animals entering or residing in that area. Alternatively, two or more wireless communication devices may define a boundary of desired shape, enabling counting or registering animals that cross that boundary. A single wireless communication device may also mark a certain location of interest, to enable counting or registering animals that are nearby or frequently visit that location.

By assigning such a wireless communication device to an animal management effector and registering an indication of the assigning, an animal management function associated with the animal management effector can advantageously be taken into account, in particular in a highly versatile manner, as part of the automated animal management, which may thus be enhanced. For example, such an indication and/or such a function may be automatically combined with other data, e.g. in an animal management system, in particular to partly or fully automate one or more animal management decisions and/or to better inform operational, tactical and/or strategic decision making in the context of animal management.

Meanwhile, accuracy and reliability can be maintained or improved with respect to known methods, and costs can be kept low, in particular in view of the improved versatility which may obviate complicated customization of communication devices and/or animal management effectors.

The automatic determining may in particular be performed in response to the wireless communication. Alternatively or additionally, the automatic determining may for example be performed in case it is determined that the wireless communication is absent, e.g. has not started and/or has ended.

In the context of the present disclosure, the term animal shall be understood as referring to a non-human animal, such as a farm animal or a zoo animal. Examples of animals include but are not limited to: cattle, pigs, sheep, goats, horses, and chickens.

Optionally, one or more further ones of the wireless communication devices may be assigned: to the same animal management effector (for example being arranged at a distance from the first wireless communication device); to a further animal management effector; to a storage location; or to a charging station. An indication of such assigning of a further device is then preferably registered in the animal management system, similar to the registering of the assigning of the first one of the wireless communication devices.

When a wireless communication device is assigned to an animal management effector and an indication of the assigning is registered, the respective wireless communication device is preferably arranged, e.g. secured in place, at the animal management effector, in particular to promote a reliable spatial association between the wireless communication device and the animal management effector.

The method may comprise causing a further one of the wireless communication devices to be carried by a further individual animal of the at least one animal. The individual animal and the further individual animal may in particular be members of a group of at least two animals, the group for example consisting of a single species or multiple species of animal. A same animal management effector associated with the animal management system may then be used in the automated management of two or more of the at least two animals.

The respective identifier of at least one of the first and second wireless communication devices may be used in one or more various ways to enable subsequent determination of the at least one parameter. For example, an indication of the identifier may be included in a message which is communicated between the wireless communication devices. Alternatively or additionally, an indication of the identifier may be used to cause a sending action and/or a receiving action as part of the communication.

Preferably, the identifiers of the wireless communication devices are mutually unique. Alternatively, two or more of the identifiers may be mutually identical, for example when respective two or more wireless communication devices are arranged at a same or similar animal management effector or are being carried by a same or similar animal. In the case of mutually identical identifiers, the number of wireless communication devices sharing a same identifier may be predetermined and/or registered in the animal management system in order to take this number into account, in particular in the automatic determining of the at least one parameter.

In the context of the present disclosure, the term animal management effector may be understood as a device, assembly, system, object, structure, piece of land, person, dog, etc. which is associated with one or more animal management functions. Thus, an animal management effector may be active or passive, physical or virtual, large or small, natural or artificial, etc. An animal management effector may be stationary, for example comprising or forming part of a stationary fencing assembly, or it may be mobile, for example comprising or forming part of a mobile feeding assembly or being formed by a person or animal with a special function such as a sheepdog or herd dog, or a herdsman. A physical effector may be provided by a real physical device or entity, and a virtual effector may be provided by one or more wireless communication devices to which an effector function may be designed.

For example, the animal management effector may comprise one or more of: an animal containing means, an animal separating means, an animal marking means; an animal sheltering means, an animal shading means, a lighting means, a heating means, a cooling means, an animal feeding means, an animal hydrating means, an animal comforting means, a measuring means, an animal inspection means, an animal breeding means, a milking means, a sheering means, a grooming means, a training means, a play means, an animal waste management means, a cleaning means, an animal treatment means, and a slaughtering means.

Preferably, the animal management relationship, in particular the at least one parameter, is defined in terms of at least one animal management function of the animal management effector with respect to the animal.

The at least one animal management function may comprise one or more of: a containing function, a separating function, a marking function, a sheltering function, a shading function, a lighting function, a heating function, a cooling function, a feeding function, a drinking function, a hydrating function, a comforting function, a measuring function, an inspection function, a breeding function, a milking function, a sheering function, a grooming function, a training function, a play function, a social behavior function, an animal waste management function, a cleaning function, a treatment function, and a slaughtering function.

Thus, a wide variety of animal management functions can benefit from the present invention.

The method may further comprise registering, in the animal management system, an indication of the carrying of the second wireless communication device by the individual animal, in particular using the identifier of the second wireless communication device.

In this way, the at least one parameter of the animal management relationship may be determined specifically for the individual animal, e.g. differently for different individual animals.

Preferably, each individual animal of the at least one animal is provided with a respective one of the wireless communication devices, such that each of the animals is thereby associated with a device identifier which is unique among the at least one animal. Respective indications of such associations are then preferably registered in the animal management system.

The method may further comprise controlling, by the animal management system, the animal management effector in dependence of the determining of the at least one parameter.

Controlling the animal management effector may comprise one or more of the following with respect to the animal management effector: activating, deactivating, powering, depowering, setting, resetting, blocking, unblocking, amplifying, suppressing, instructing, interrogating, switching, modulating, tuning, moving, directing, steering, focusing, regulating, adjusting and updating.

The controlling may be direct, for example by sending a control signal to an animal management effector which is configured to receive, in particular respond to, such a control signal, or indirect, for example by presenting a control instruction to an operator of the animal management effector.

Optionally, the determined at least one parameter is used to plan an animal management interaction between the animal management effector and the animal, and the controlling is performed in accordance with the planned animal management interaction.

For example, in case it is determined that an animal is at a gate, this may be used to plan that the animal passes through the gate, whereafter the gate is controlled to an open state so as to allow the animal to pass therethrough. Alternatively, for example for a different animal, at a different time, or given a different circumstance, it may be planned that the animal does not pass through the gate, whereafter the gate is controlled to a closed state so as to prevent that the animal passes therethrough.

The planning of the animal management interaction may comprise evaluating an animal management policy for the respective individual animal with respect to the animal management effector, for example triggered by the determined at least one parameter.

For example, such a policy may be evaluated to determine whether or not it is desired that the animal passes through the gate, wherein it is planned that the animal passes through the gate in case this is desired, and/or it is planned that the animal does not pass through the gate in case this is not desired.

Optionally, the at least one parameter of the animal management relationship is, at least comprises, at least one parameter of a physical relationship between the animal and the animal management effector.

For example, the at least one parameter may comprise one or more of the following with respect to the animal and the animal management effector: mutual presence, mutual absence, mutual proximity, mutual distance, mutual direction, mutual orientation, mutual movement, and a parameter related to mutual interaction or interactability (e.g. contact, actuation, actuatability, observability, communicability).

Optionally, the method further comprises recording an indication of the determining of the at least one parameter in a memory associated with the animal management system, the indication preferably comprising the determined at least one parameter.

For example, the indication of the determining may comprise and/or correspond to the at least one parameter. Alternatively or additionally, the indication may comprise and/or correspond to a result of comparing the parameter to a predetermined reference such as a threshold or a range.

Optionally, the assigning of the first one of the wireless communication devices to the animal management effector comprises arranging said first one of the wireless communication devices at the animal management effector and/or fixing a position of said first one of the wireless communication devices with respect to a position of the animal management effector. The position of the first one of the wireless communication devices may thus be at the animal management effector, for example in, on, adjacent, in a vicinity of, and/or in an operating area of, the animal management effector.

For example, the fixing may comprise mechanically connecting said first one of the wireless communication devices and the animal management effector to each other, for example mounting the device to the effector. Alternatively, for example in case of a substantially stationary position of the animal management effector, the first one of the wireless communication devices may be mechanically connected to a structure nearby, e.g. adjacent, the animal management effector, in particular in an operating area of the animal management effector.

Optionally, the causing of a second one of the wireless communication devices to be carried by an individual animal comprises mechanically connecting said second one of the wireless communication devices and said animal to each other, for example suspending the device on and/or in the animal's body.

For example, the wireless communication device may be suspended from a neck of the animal, e.g. by a collar. As a further example, the wireless communication device may be strapped to a leg of the animal.

Optionally, the causing of a wireless communication between at least the first and second wireless communication devices comprises: by one of the first and second wireless communication devices, sending a signal or message; and by another of said devices, receiving the signal or message; wherein the automatic determining of the at least one parameter comprises processing the received signal or message.

Preferably, the signal or message comprises the respective identifier of at least one of the first and second wireless communication devices.

Optionally, a plurality of assigned first wireless communication devices are arranged with mutual interspacing at, for example along, the animal management effector, so as to jointly correspond to a boundary defined by and/or for the animal management effector, wherein the automatically determined at least one parameter comprises an indication of a spatial relationship between the animal and the boundary.

The spatial relationship between the animal and the boundary may correspond to a side of the boundary where the animal is, a crossing of the boundary by the animal, and/or a proximity of the animal to the boundary. The boundary may for example enclose an area and/or mutually separate two areas. The boundary may be designed to be crossable, not crossable, or selectively crossable by the animal.

According to a further aspect, a method for managing a group of animals comprises performing a method for automated animal management as described herein, wherein each individual animal of the group of animals is provided with a respective one of the wireless communication devices.

Preferably, the determining of the at least one parameter of the animal management relationship comprises identifying the respective individual animal using the respective identifier of the wireless communication device carried by said animal.

A further aspect provides a parameter determination system for use in a method for automated animal management of at least one animal, in particular as described herein. The parameter determination system comprises a plurality of wireless communication devices, each of the wireless communication devices being configured for being carried by an animal and having a respective identifier associated therewith in the system. The parameter determination system further comprises: a registration unit for registering an indication of an arranging of a first one of the wireless communication devices at an animal management effector; a communication driver for causing a wireless communication between at least the first one and a second one of the wireless communication devices using the respective identifier of at least one of said first and second wireless communication devices; and a parameter determination unit for automatically determining at least one parameter of an animal management relationship between an individual animal and the animal management effector in dependence of the wireless communication, using the indication of the arranging as registered in the registration unit.

Such a parameter determination system provides above described advantages.

Preferably, the registration unit is further configured for registering an indication of a carrying of the second wireless communication device by the animal, in particular using the identifier of the second wireless communication device.

Optionally, the parameter determination system comprises a recording unit which is configured to record an indication of the determined at least one parameter in a memory associated with the parameter determination system.

Optionally, the parameter determination system is configured to estimate one or more mutual distances and/or directions between the wireless communication devices, in particular based on wireless communication between said devices.

A further aspect provides an animal management system for automated animal management of at least one animal, comprising the parameter determination system as described herein and the animal management effector.

Preferably, at least during use, the first one of the wireless communication devices is arranged at the animal management effector.

Optionally, the animal management system comprises a control unit which is configured to control the animal management effector in dependence of the determined at least one parameter.

To enable such control by the control unit, the animal management effector may be configured to be controlled at least partly by an external controller, in particular by the control unit. To exercise the control, the control unit may be connected to the animal management effector, for example wirelessly or via a wired connection.

According to a further aspect, a parameter determination system and/or animal management system as described herein is used in a method for automated animal management as described herein.

### DETAILED DESCRIPTION

In the following, the invention will be explained further using exemplary embodiments and drawings. The drawings are schematic and merely show examples. In the drawings, corresponding elements have been indicated using corresponding reference signs. In the drawings:

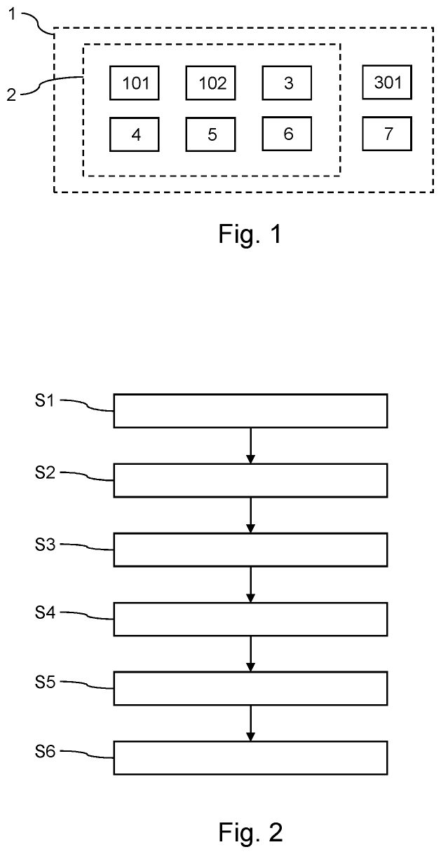

FIG. 1 shows a block diagram of an exemplary animal management system;

FIG. 2 shows a flow chart illustrating activities in an exemplary method of automated animal management.

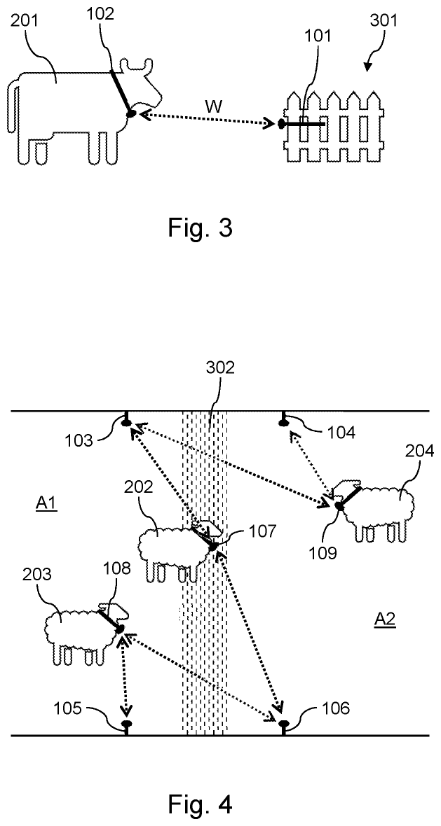

FIG. 3 shows a side view of an exemplary situation with an animal management effector, an animal, and two wireless communication devices;

FIG. 4 shows a map view of an exemplary situation with an animal management effector, three animals, and seven wireless communication devices; and

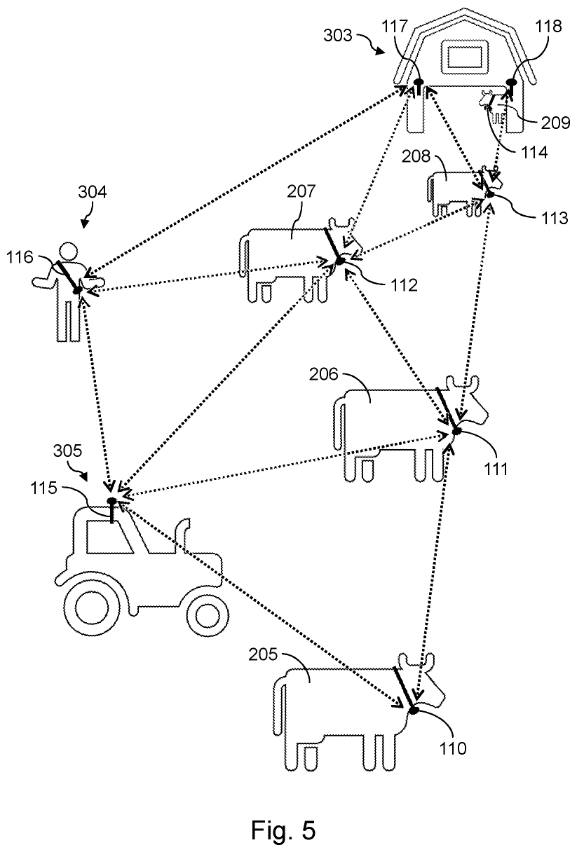

FIG. 5 shows a bird's eye view of an exemplary situation with three animal management effectors, five animals and eight wireless communication devices.

FIG. 1 shows a block diagram of an exemplary animal management system 1 for automated animal management of at least one animal. The automated animal management system 1 comprises an exemplary parameter determination system 2, in particular as a subsystem of the animal management system 1.

The parameter determination system 2 comprises a plurality of wireless communication devices 101, 102. Although two such wireless communication devices 101, 102 are shown in FIGS. 1 and 3, it will be appreciated that the system 2 may comprise a larger number of such wireless communication devices 101-118, as will be explained further with reference to FIGS. 4 and 5.

Each of the wireless communication devices 101-118 is configured for being carried by an animal 201-209 (examples shown in FIGS. 3-5) and has a respective identifier associated therewith in the system 2.

The animal management system 1 here further comprises an animal management effector 301-305. While one such animal management effector 301 is shown in FIG. 1, it will be appreciated that further animal management effectors 302-305 may be provided, as will be discussed with reference to FIGS. 4 and 5.

The parameter determination system 2 further comprises: a registration unit 3 for registering an indication of an assigning of a first one of the wireless communication devices 101-118 at the animal management effector 301-305; a communication driver 4 for causing a wireless communication between at least the first one and a second one of the wireless communication devices 101-118 using the respective identifier of at least one of said first and second wireless communication devices 101-118; and a parameter determination unit 5 for automatically determining at least one parameter of an animal management relationship between an individual animal 201-209 and the animal management effector 301-305 in dependence of the wireless communication, using the indication of the assigning as registered in the registration unit 3.

While in FIG. 1 components of the systems 1 and 2 are shown as mutually distinct, it will be appreciated that they may in fact share one or more parts and/or resources, for example a shared processor, a shared memory, a shared power supply, etc. Unless otherwise indicated, such components and/or parts thereof may generally be arranged together, for example in a central or remote location, or apart, for example distributed across the wireless communication devices.

The parameter determination system 2 and/or the animal management system 1 may be used in a method for automated animal management of at least one animal. FIG. 2 shows a flow chart illustrating a method. The method comprises using, in step S1, an animal management system 1 including an animal management effector 301-305 and a plurality of wireless communication devices 101-118, each of the wireless communication devices 101-118 having a respective identifier associated therewith in the system 1.

The method further comprises assigning, in step S2, a first one of the wireless communication devices 101-118 to the animal management effector 301-305 and registering S3, in the animal management system 1, an indication of the assigning. Such assigning may comprise, e.g. consist of, arranging the animal management effector 301-305 at the animal management effector 301-305. In the examples of FIGS. 3-5, one or more respective wireless communication devices 101, 103-106, and 115-118 can be seen to have been arranged at animal management effectors 301-305.

In an optional case of a virtual management effector, such arranging may itself serve to define the animal management effector. For example, arranging one or more first wireless communication devices may thereby define a position, region, and/or boundary which can then be regarded as, at least associated with, an animal management effector. Such a position, region and/or boundary may alternatively or additionally be predefined, e.g. on a floor plan or the like.

The method further comprises causing, in step S4, a second one of the wireless communication devices 101-118 to be carried by an individual animal of the at least one animal 201-209. In the examples of FIGS. 3-5, wireless communication devices 102, 107-109, and 110-114 can be seen to be carried by a respective animal 201-209.

The method further comprises, using the respective identifier of at least one of the first and second wireless communication devices 101-118, causing, in step S5, a wireless communication between at least said first and second wireless communication devices. For example, in FIG. 3, such a wireless communication has been schematically indicated by a double arrow W with a dotted line. In FIGS. 4 and 5 further such exemplary wireless communications have been schematically indicated by such double arrows. In FIG. 5 it can be seen that such a wireless communication between first and second wireless communication devices, for example between devices 111 and 117, may be indirect, in particular relayed by a further wireless communication device, like device 112 and/or 113 in this example. In particular, such wireless communications may thus occur within and/or via a mesh-type or other network which may be at least partly formed by some or all of the wireless communication devices. In any case, such wireless communications may be realized in various ways and may thus follow different and/or additional routes compared to what is shown in FIG. 3-5.

The method further comprises automatically determining, in step S6, by the animal management system 1, using the registered indication of the assigning, at least one parameter of an animal management relationship between the animal 201-209 and the animal management effector 301-305 in dependence of the wireless communication.

With reference to FIGS. 4 and 5, an exemplary method for managing a group of animals, e.g. 202-204 or 205-209, comprises performing the method for automated animal management S1-S6, wherein each individual animal of the group of animals is provided with a respective one of the wireless communication devices 101-118.

The assigning of the first one of the wireless communication devices 101-118 to the animal management effector 301-305 may comprise arranging said first one of the wireless communication devices 101-118 at the animal management effector 301-305 and/or fixing a position of said first one of the wireless communication devices 101-118 with respect to a position of the animal management effector 301-305.

In the exemplary use situation of FIG. 3, a first one 101 of the wireless communication devices is arranged at, in particular fixed to, a fence as an animal management effector 301.

Further in FIG. 3, a second one 102 of the wireless communication devices is carried by an individual animal 201, here a cow. Here, an animal management function of the fence 301 may be to contain the cow 201 in a particular area on one side of the fence, for example.

The causing of a second one of the wireless communication devices 101-118 to be carried by an individual animal 201-209 may comprise mechanically connecting said second one of the wireless communication devices 101-118 and said animal 201-209 to each other, for example suspending the device on and/or in the animal's body. In the examples shown, respective wireless communication devices are suspended from the necks of the animals. As a possible alternative, such a device may be strapped to a leg of the animal, for example.

As alluded to above, with continued reference to FIG. 3, a wireless communication W can be caused between the wireless communication devices 101, 102, using the respective identifier of either or both devices 101, 102.

In FIGS. 3-5, such wireless communications are schematically represented by dotted lines with double arrows. It shall be appreciated that such a wireless communication may in practice not follow any straight or direct path and may or may not be bidirectional. For clarity of the drawings, the dotted lines with double arrows have not been provided with reference signs in FIGS. 4 and 5.

The causing of a wireless communication between at least the first and second wireless communication devices 101-118 may comprise: by one of the first and second wireless communication devices 101-118, sending a signal or message; and by another of said devices 101-118, receiving the signal or message.

In dependence of, in particular in response to, the wireless communication W, the animal management system 1 may automatically determine one or more parameters of an animal management relationship between, in the example of FIG. 3, the fence 301 and the cow 201. The automatic determining of the at least one parameter may comprise processing the received signal or message.

In FIG. 3, possible examples of parameters which may be automatically determined include: an estimated distance between the fence 301 and the cow 201; and an estimated relative movement direction of the cow 201 with respect to the fence 301. To that end, the parameter determination system 2 may be configured to estimate one or more mutual distances and/or directions between the wireless communication devices 101, 102, in particular based on the wireless communication W.

An indication of the arranging of the first wireless communication device 101 at the fence 301, which indication has been registered in the animal management system 1, in particular in the registration unit 4, as an indication of an assigning of the device 101 to the fence 301, is used in the automatic determining.

With reference to a further exemplary use situation shown in FIG. 4, a plurality of first wireless communication devices 103-106 may be arranged with mutual interspacing at the animal management effector 302, so as to jointly correspond to a boundary defined by and/or for the animal management effector 302. In this example, the animal management effector 302 represents a crossable boundary between two areas A1, A2 in which the animals 202-204, here sheep, can be located. It shall be appreciated that such a crossable boundary 302 may be physical, for example associated with a physical floor element, or virtual, for example associated with a marking on a map and/or being defined by the positions of the respective devices 103-106.

The automatically determined at least one parameter may comprise an indication of a spatial relationship between the animal 202-204 and the boundary. For example, in the situation of FIG. 4, it may thus be determined that: sheep 203 is in area A1, at least on a side of the boundary 302 corresponding to area A1; sheep 204 is in area A2, at least on an opposite side of the boundary 302 corresponding to area A2; and sheep 202 is at the boundary 302 between the areas A1 and A2. To enable such determinations, the system 1 may first determine one or more respective distances between the sheep 202-204 and the wireless communication devices 103-106 which have been arranged at the boundary 302.

FIG. 5 shows a still further exemplary use situation which includes several animal management effectors 303-305, namely: an animal management building 303, for example a cowshed or a milking facility, in particular an entrance thereof; an animal management person 304, for example a farmer or a farm hand; and an animal management vehicle 305, for example an off-road vehicle such as a tractor.

It can thus be seen that animal management effectors can be of various types and be associated with various animal management functions.

The animal management relationship, in particular the at least one parameter, may be defined in terms of at least one animal management function of the animal management effector 301-305 with respect to the animal 201-209.

The at least one animal management function may comprise one or more of: a containing function, a separating function, a marking function, a sheltering function, a shading function, a lighting function, a heating function, a cooling function, a feeding function, a drinking function, a hydrating function, a comforting function, a measuring function, an inspection function, a breeding function, a milking function, a sheering function, a grooming function, a training function, a play function, a social behavior function, an animal waste management function, a cleaning function, a treatment function, and a slaughtering function. Behavioral functions, such as social behavior, may be directed for example at habits or interactional behavior of an animal. For example, social behavior may include the behavior of an individual animal in a group, the interaction with (certain) other individual animals, the forming of sub-groups within a herd, or the detection of social stress or relief.

As alluded to in the above described examples, the at least one parameter of the animal management relationship may be or comprise at least one parameter of a physical relationship between the animal 201-209 and the animal management effector 301-305, for example a mutual position, distance, orientation and/or proximity, a mutual movement, e.g. speed and/or direction, etc.

Returning to FIG. 1, the parameter determination system 2 may further comprise a recording unit 6 which is configured to record an indication of the determined at least one parameter in a memory associated with the parameter determination system 2.

The method may further comprise recording an indication of the determining of the at least one parameter in a memory associated with the animal management system 1, the indication preferably comprising the determined at least one parameter.

Preferably, the registration unit 3 is further configured for registering an indication of a carrying of the second wireless communication device by the animal 201-209, in particular using the identifier of the second wireless communication device.

The method may further comprise registering, in the animal management system 1, an indication of the carrying of the second wireless communication device by the individual animal, in particular using the identifier of the second wireless communication device.

Preferably, the determining of the at least one parameter of the animal management relationship comprises identifying the respective individual animal using the respective identifier of the wireless communication device carried by said animal.

Optionally, the animal management system 1 comprises a control unit 7 which is configured to control the animal management effector 301-305 in dependence of the determined at least one parameter.

The method may further comprise controlling, by the animal management system 1, the animal management effector 301-305 in dependence of the determining of the at least one parameter. For example, a gate as an animal management effector may be controlled to open or close. Further examples of controllable animal management effectors include milking facilities, feeding facilities, etc.

The determined at least one parameter may be used to plan an animal management interaction, for example a milking interaction or a feeding interaction, between the animal management effector and the animal, and the controlling may be performed in accordance with the planned animal management interaction.

While the invention has been explained herein with reference to exemplary embodiments and drawings, these do not limit the scope of the invention as defined by the appended claims. Many variations, combinations and extensions are possible, as will be appreciated by the skilled person. Examples thereof have been provided throughout the description.

1. A method for performing animal management of at least one animal, the method comprising:
using an animal management system including a plurality of wireless communication devices, wherein each wireless communication device, of the plurality of wireless communication devices, has a respective identifier associated therewith in the system;
assigning a first wireless communication device, of the plurality of wireless communication devices, to an animal management effector and registering, in the animal management system, an indication of the assigning the first wireless communication device to the animal management effector;
causing a second wireless communication device, of the plurality of wireless communication devices, to be carried by an individual animal of the at least one animal;
causing, using the respective identifier of at least one of the first wireless communication device and the second wireless communication device, a wireless communication between at least the first wireless communication device and the second wireless communication device; and
determining, by the animal management system using the registered indication of the assigning, at least one parameter of an animal management relationship between the animal and the animal management effector in accordance with the wireless communication.

2. The method according to claim 1, wherein the animal management relationship is defined in terms of at least one animal management function of the animal management effector with respect to the animal.

3. The method according to claim 2, wherein the at least one animal management function comprises at least one function taken from the Group consisting of: a containing function, a separating function, a marking function, a sheltering function, a shading function, a lighting function, a heating function, a cooling function, a feeding function, a drinking function, a hydrating function, a comforting function, a measuring function, an inspection function, a breeding function, a milking function, a sheering function, a grooming function, a training function, a play function, a social behavior function, an animal waste management function, a cleaning function, a treatment function, and a slaughtering function.

4. The method according to claim 1, further comprising:
registering, in the animal management system, an indication of the carrying of the second wireless communication device by the individual animal.

5. The method according to claim 1, further comprising:
controlling, by the animal management system, the animal management effector in accordance with the determining of the at least one parameter.

6. The method according to claim 5, wherein the determined at least one parameter is used to plan an animal management interaction between the animal management effector and the animal, and
wherein the controlling is performed in accordance with the planned animal management interaction.

7. The method according to claim 1, wherein the at least one parameter of the animal management relationship comprises at least one parameter of a physical relationship between the animal and the animal management effector.

8. The method according to claim 1, further comprising recording an indication of the determining of the at least one parameter in a memory associated with the animal management system.

9. The method according to claim 1, wherein the assigning of the first one of the wireless communication devices to the animal management effector comprises arranging the first one of the wireless communication devices at the animal management effector and/or fixing a position of the first one of the wireless communication devices with respect to a position of the animal management effector.

10. The method according to claim 1, wherein the causing of a second one of the wireless communication devices to be carried by an individual animal comprises mechanically connecting the second one of the wireless communication devices and the animal to each other, for example suspending the device on and/or in the animal's body.

11. The method according to claim 1, wherein the causing of a wireless communication between at least the first and second wireless communication devices comprises:
by one of the first and second wireless communication devices, sending a signal or message; and
by another of the devices, receiving the signal or message;
wherein the automatic determining of the at least one parameter comprises processing the received signal or message.

12. The method according to claim 1, wherein a plurality of assigned instances of the first wireless communication device are arranged with mutual interspacing at the animal management effector, so as to jointly correspond to a boundary defined by and/or for the animal management effector, wherein the automatically determined at least one parameter comprises an indication of a spatial relationship between the animal and the boundary.

13. A method for performing animal management of a group of animals by an animal management system including a plurality of wireless communication devices, wherein each wireless communication device, of the plurality of wireless communication devices, has a respective identifier associated therewith in the system, wherein the method comprises performing, for each animal of the group of animals, a method for animal management comprising:
assigning a first wireless communication device, of the plurality of wireless communication devices, to an animal management effector and registering, in the animal management system, an indication of the assigning the first wireless communication device to the animal management effector;
causing a second wireless communication device, of the plurality of wireless communication devices, to be carried by an individual animal of the at least one animal;
causing, using the respective identifier of at least one of the first wireless communication device and the second wireless communication device, a wireless communication between at least the first wireless communication device and the second wireless communication device; and
determining, by the animal management system using the registered indication of the assigning, at least one parameter of an animal management relationship between the animal and the animal management effector in accordance with the wireless communication.

14. A parameter determination system for use to perform the method for automated animal management of at least one animal of claim 1, the parameter determination system comprising:
a plurality of wireless communication devices, each wireless communication device of the plurality of wireless communication devices is configured for being carried by an animal and having a respective identifier associated therewith in the system;
a registration unit configured to register an indication of an assigning of a first wireless communication device of the plurality of wireless communication devices to an animal management effector;
a communication driver configured to cause a wireless communication between at least the first wireless communication device and a second wireless communication device of the plurality of wireless communication devices using a respective identifier of at least one of the first wireless communication device and the second wireless communication device; and
a parameter determination unit configured to determine at least one parameter of an animal management relationship between an individual animal and the animal management effector in accordance with the wireless communication, using the indication of the arranging as registered in the registration unit.

15. The parameter determination system according to claim 14, wherein the registration unit is further configured to register, using the identifier of the second wireless communication device, an indication of a carrying of the second wireless communication device by the animal.

16. The parameter determination system according to claim 14, comprising a recording unit which is configured to record an indication of the determined at least one parameter in a memory associated with the parameter determination system.

17. The parameter determination system according to claim 14, configured to estimate one or more mutual distances and/or directions between the wireless communication devices, in particular based on wireless communication between the devices.

18. An animal management system for automated animal management of at least one animal, comprising the parameter determination system according to claim 14 and an animal management effector, wherein during use the first wireless communication device of the wireless communication devices is arranged at the animal management effector.

19. The animal management system according to claim 18, comprising a control unit that is configured to control the animal management effector in accordance with the determined at least one parameter.

20. (canceled)
